(19) United States
(12) Patent Application Publication
(10) Pub. No.: US 2013/0263648 A1
(43) Pub. Date: Oct. 10, 2013

(54) VALVE DEVICE AND FUEL-VAPOR LEAK DETECTION DEVICE USING THE SAME

(71) Applicant: DENSO CORPORATION, Kariya-city (JP)

(72) Inventor: Makoto KANEKO, Nishio-city (JP)

(73) Assignee: Denso Corporation, Kariya-city (JP)

(21) Appl. No.: 13/856,742

(22) Filed: Apr. 4, 2013

(30) Foreign Application Priority Data
Apr. 6, 2012 (JP) 2012-87763

(51) Int. Cl. G01M 3/32

(52) U.S. Cl. CPC G01M 3/3272
USPC 73/49.2; 137/561 R; 251/333

(57) ABSTRACT

A valve device includes a first valve body including a first seat portion that defines a first opening, a shaft reciprocatable in a direction of a center axis of the first opening, and a first valve member supported by the shaft to contact or be separated from the first seat portion in accordance with the reciprocation of the shaft. The first valve member contacts the first seat portion in an entire circumference of the first seat portion with deforming elastically due to a force from the first seat portion when the first valve member contacts the first seat portion in a state where a reciprocation direction of the shaft is inclined from the center axis of the first opening. Accordingly, air sealing of the valve device can be ensured even when the reciprocation direction of the shaft is inclined from the center axis of the first opening.

### CROSS REFERENCE TO RELATED APPLICATION

This application is based on and incorporates herein by reference Japanese Patent Application No. 2012-087763 filed on Apr. 6, 2012.

### TECHNICAL FIELD

The present disclosure relates to a valve device and a fuel-vapor leak detection device including the valve device.

### BACKGROUND

Conventionally, a fuel-vapor leak detection device is known, which detects a leakage of fuel vapor from a fuel tank. The fuel-vapor leak detection device includes a pump which pressurizes or depressurizes an inside of the fuel tank, and a switching valve which switches between a communication between the fuel tank and the pump and a communication between the fuel tank and an atmosphere.

The switching valve is an electromagnetic valve, and includes a fixed core, a coil, a movable core, a support member that accommodates the movable core slideably, a shaft that moves together with the movable core, a valve member provided in an edge part of the shaft, and a seat portion that contacts or is separated from the valve member. When the coil is energized, an attraction force is generated between the movable core and the fixed core. The attraction force causes the movable core to reciprocate inside the support member. A clearance is provided between an outer wall of the movable core and an inner wall of the support member so that the movable core is capable of moving smoothly. Hence, a moving direction of the movable core may be inclined from a center axis of an opening provided in the seat portion. In this case, the valve member does not contact the seat portion in an entire circumference of the seat portion, and an air sealing of the switching valve may be affected. In Patent Document 1 (JP 2007-071146 A corresponding to US 2007/0051168 A1), a switching valve of a fuel-vapor leak detection device includes a valve member having a recess part having a bottomed cylindrical shape, i.e., a hemispherical shape. The switching valve includes a shaft having an edge part formed in a hemispherical shape to contact the recess part of the valve member. Even when a reciprocation direction of the shaft is inclined from a center axis of an opening provided in a seat portion of the switching valve, the edge part of the shaft point-contacts the recess part of the valve member, and the valve member thereby contacts the seat portion in its entire circumference.

The edge part of the shaft of the fuel-vapor leak detection device described in Patent Document 1 is formed in the hemispherical shape. Thus, a manufacturing cost of the shaft may become high. The recess part of the valve member, which contacts the edge part of the shaft, is also formed into the hemispherical shape. Additionally, in order to ensure an air sealing of the switching valve, a rubber material is burned into a contact part of the valve member that contacts the seat portion. As a result, a manufacturing cost of the switching valve may become high.

The conventional fuel-vapor leak detection device further includes a resin receiving part that contacts the edge part of the shaft, a rubber contact portion that contacts the seat portion, and a spring which urges the receiving part toward the shaft. The contact portion has a flat shape, and the shaft may be required to be applied a force corresponding to a sum of forces which includes a necessary force for making the contact portion be in contact with the seat portion in its entire circumference and a force against an urging force of the spring. As a result, an electric power supplied to the coil may increase, and a temperature of the switching valve may increase. Therefore, a range of ambient temperature within which the fuel-vapor leak detection device is operable may become narrow.

### SUMMARY

It is an objective of the present disclosure to provide a valve device capable of being provided in low cost while ensuring an air sealing of the valve device even in a case where a reciprocation direction of a shaft is inclined from a center axis of an opening of a seat portion.

According to an aspect of the present disclosure, a valve device includes a first valve body, a shaft and a first valve member. The first valve body includes a first seat portion that defines a first opening, and the shaft is reciprocatable in a direction of a center axis of the first opening. The first valve member is supported by the shaft to contact or be separated from the first seat portion in accordance with the reciprocation of the shaft. The first valve member contacts the first seat portion in an entire circumference of the first seat portion with deforming elastically due to a force from the first seat portion when the first valve member contacts the first seat portion in a state where a reciprocation direction of the shaft is inclined from the center axis of the first opening.

When the reciprocation direction of the shaft is inclined from the center axis of the first opening, a part of the first valve member that contacts the first seat portion firstly is deformed so that the first valve member contacts the first seat portion in the entire circumference of the first seat portion. Accordingly, a process of shaping the first valve member into a hemispherical shape for example can be omitted, and a manufacturing cost of the valve device can be thereby reduced.

Because the first valve member is supported by the shaft in the present disclosure, a spring urging the first valve member toward the shaft can be omitted. Hence, a force applied to the shaft in opening or closing of the valve device can be reduced. Additionally, the first valve member deforms after a part of the first valve member contacts the first seat portion. Thus, the first valve member can be made to be in contact with the first seat portion with a relatively small force. As a result, air sealing of the valve device can be ensured with a relatively small force. In other words, a necessary force for reciprocating the shaft can be reduced, and a consumption amount of energy in driving of the valve device can be thereby reduced. By reducing the energy consumption, a temperature of the valve device becomes difficult to increase. Accordingly, a range of ambient temperature within which the valve device is operable can be expanded.

### BRIEF DESCRIPTION OF THE DRAWINGS

The disclosure, together with additional objectives, features and advantages thereof, will be best understood from the following description, the appended claims and the accompanying drawings, in which:

FIG. 1 is a sectional view showing a fuel-vapor leak detection device including a first valve according to a first embodiment of the present disclosure;

FIG. 2 is a schematic diagram showing a fuel-vapor treatment system including the fuel-vapor leak detection device shown in FIG. 1;

FIG. 3A is a sectional view showing the first valve open, according to the first embodiment;

FIG. 3B is a sectional view showing the first valve closed, according to the first embodiment;

FIG. 4A is a sectional view showing a first valve open, according to a second embodiment of the present disclosure; and

FIG. 4B is a sectional view showing the first valve closed, according to the second embodiment.

### DETAILED DESCRIPTION

Embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

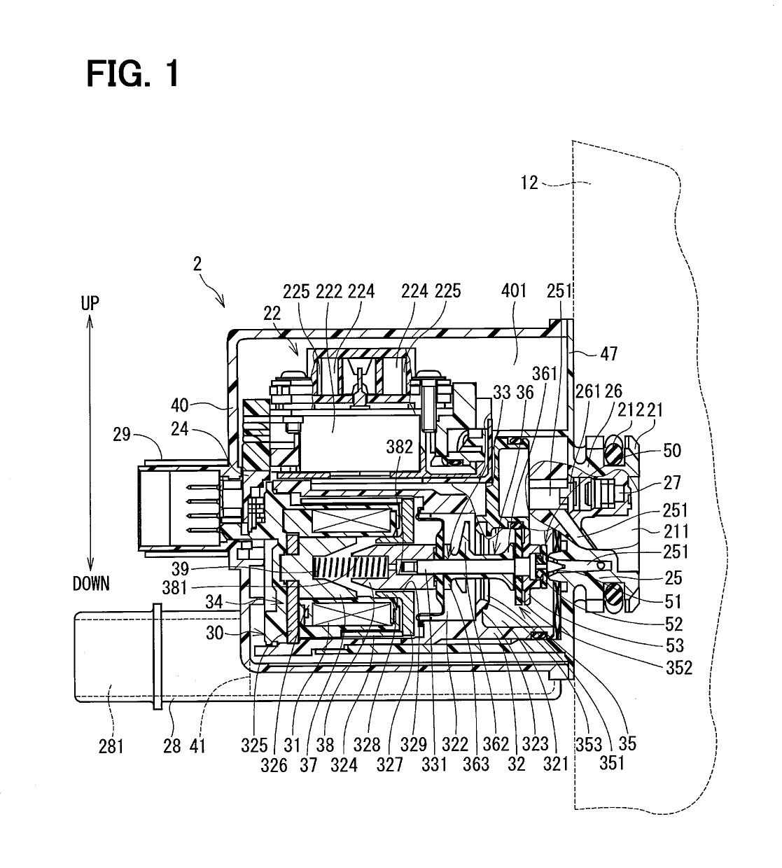

A first embodiment of the present disclosure will be described in reference to FIGS. 1 to 3B. A valve device of the present disclosure is used for a fuel-vapor leak detection device 2 of a fuel-vapor treatment system 1, for example.

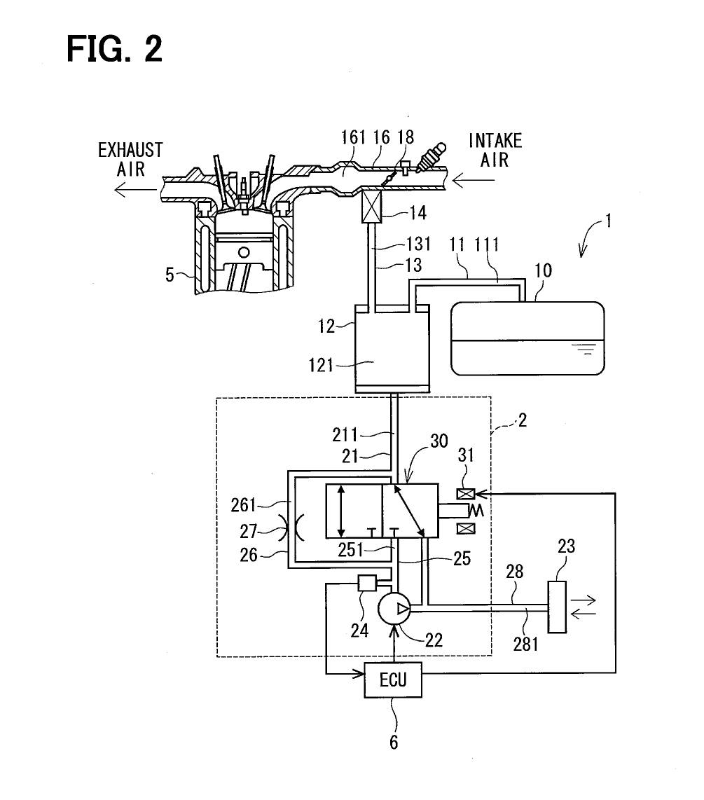

Firstly, the fuel-vapor treatment system 1 including the fuel-vapor leak detection device 2 will be described referring to FIG. 2. The fuel-vapor treatment system 1 retrieves fuel vapor generated from a fuel tank 10 that accumulates therein fuel for combustion in an engine 5, and the fuel-vapor treatment system 1 supplies the retrieved fuel vapor to the engine 5. The fuel-vapor leak detection device 2 detects a leakage of fuel vapor from the fuel tank 10, a first purge pipe 11, a canister 12 and a second purge pipe 12 to outside.

The fuel-vapor treatment system 1 includes the fuel tank 10, the canister 12, the fuel-vapor leak detection device 2, a filter 23 and an electronic control unit 6 (ECU). In the fuel-vapor treatment system 1, the canister 12 retrieves the fuel vapor generated in the fuel tank 10. The canister 12 discharges the retrieved fuel vapor to an intake passage 161 of an intake pipe 16 connected to the engine 5.

The fuel tank 10 stores therein fuel that is to be supplied to the engine 5. The fuel tank 10 is connected to the canister 12 via the first purge pipe 11. The first purge pipe 11 defines a first purge passage 111 through which an inside of the fuel tank 10 communicates with an inside of the canister 12.

The canister 12 includes an adsorption member 121 that retrieves the fuel vapor generated in the fuel tank 10. The canister 12 is connected to the intake pipe 16 via the second purge pipe 13 that defines a second purge passage 131. The fuel vapor generated in the fuel tank 10 flows through the first purge passage 111 to be adsorbed to the adsorption member 121, thereby being retrieved. A purge valve 14 is provided in the second purge pipe 13. The purge valve 14 is an electromagnetic valve, and an open degree of the purge valve 14 is controlled such that an amount of fuel vapor supplied from the canister 12 to the intake passage 161 is adjusted. Specifically, the fuel vapor is supplied from the canister 12 to a downstream side of a throttle valve 18 in a flow direction of an intake air in the intake passage 161.

The fuel-vapor leak detection device 2 includes a canister connection portion 21, a pump 22, a switching valve 30, a pressure sensor 24, a pressure detection pipe 25, a bypass pipe 26, an orifice 27 and an atmosphere pipe 28.

The filter 23 is connected to an end of the atmosphere pipe 28 on a side of the atmosphere pipe 28 toward atmosphere. The atmosphere pipe 28 defines an atmosphere passage 281 communicating with the atmosphere. The atmosphere pipe 28 is used as an example of an atmosphere passage forming member that defines the atmosphere passage 281. Air in the fuel tank 10 or air in the canister 12 is discharged to the atmosphere through the filter 23, (i) when fuel vapor is adsorbed to the canister 12, (ii) when the pump 22 depressurizes the inside of the fuel tank 10, or (iii) when fuel is supplied into the fuel tank 10. On the other hand, air in the atmosphere is introduced into the fuel-vapor leak detection device 2 through the filter 23, (i) when fuel vapor absorbed to the canister 12 is supplied to the intake pipe 16, (ii) when the pump 22 pressurizes the inside of the fuel tank 10, or (iii) when a reference pressure is detected in a fuel-vapor leak detection process described later. When air is introduced into the fuel-vapor leak detection device 2 through the filter 23, the filter 23 traps foreign materials contained in the introduced air. Arrows drawn adjacent to the filter 23 in FIG. 2 represent flows of air.

The ECU 6 includes a central processing unit (CPU) and a microcomputer that includes a random access memory (RAM) and a read-only memory (ROM). The CPU is used as a computing device, and the microcomputer is used as a storage device. The ECU 6 is electrically connected to the pressure sensor 24, the pump 22 and a coil 31 of the switching valve 30. The pressure sensor 24 detects a pressure in a pressure detection passage 251 of the pressure detection pipe 25, and the ECU 6 receives a signal dependent on the pressure detected by the pressure sensor 24. The ECU 6 outputs a signal to control an operation of the pump 22. The ECU 6 controls an energization of the coil 31.

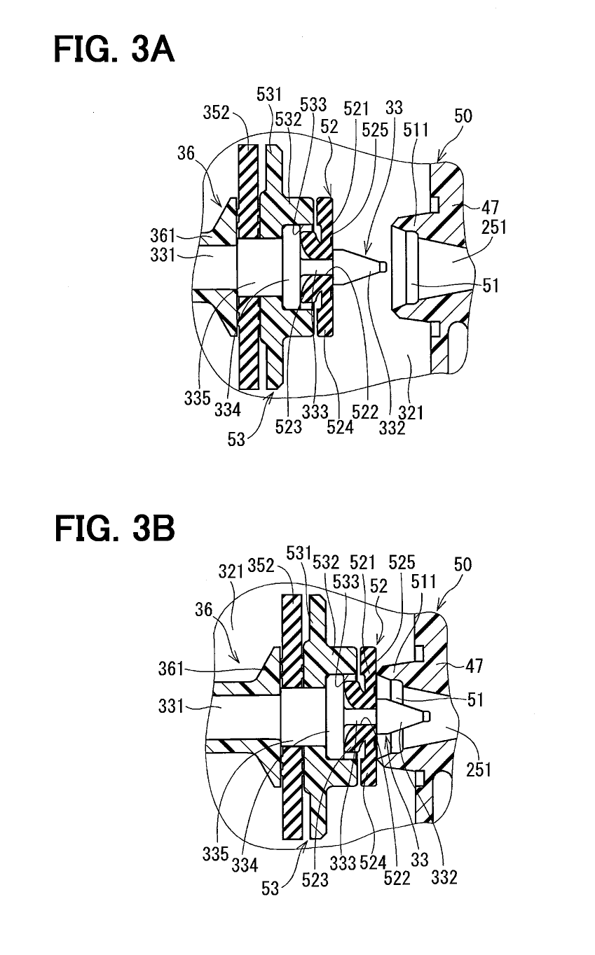

Next, the fuel-vapor leak detection device 2 will be described with reference to FIGS. 1, 3A and 3B. The fuel-vapor leak detection device 2 of the first embodiment includes a housing 40 having a bottomed cylindrical shape. The housing 40 accommodates therein the pump 22, the switching valve 30 and the pressure sensor 24 to be modularized. The fuel-vapor leak detection device 2 further includes a cover 47 that closes an opening of the housing 40. The canister connection portion 21 is connected to the cover 47, and the canister connection portion 21 is fitted to an attachment hole provided in a side wall of the canister 12 such that the fuel-vapor leak detection device 2 is fixed to the canister 12. In a housing space 401 provided inside the housing 40, the pump 22 is located on an upper side of the switching valve 30 in an up-down direction in FIG. 1. The pump 22 may be located on the upper side of the switching valve 30 in a gravity direction. The pressure sensor 24 is located on a side of the switching valve 30 opposite from the canister connection portion 21. The fuel-vapor leak detection device 2 further includes a connector 29 attached to a side wall of the housing 40 opposite from the cover 47, in other words, the connector 29 is attached to a bottom part of the housing 40. The connector 29 receives an electric power supplied from outside. In FIG. 1, a direction toward an upper side is referred to as an upper direction, and a direction toward a lower side is referred to as a lower direction.

The housing 40 is made of a resin cuboid to have the bottomed cylindrical shape as described above. As shown in FIG. 1, the housing 40 has an atmosphere port 41 through which the housing space 401 communicates with an outside of the housing 40. The atmosphere port 41 is provided in a side wall of the housing 40 on its side opposite from the cover 47. The atmosphere port 41 communicates with the atmosphere passage 281. An end of the atmosphere pipe 28 that defines the atmosphere passage 281 is exposed to the atmosphere. The housing space 401 communicates with the atmosphere through the atmosphere port 41 and the atmosphere passage 281.

The pump 22 is a vane pump in which a rotor 224 supporting a vane 225 is rotary-driven by a brushless DC electric motor 222. The pump 22 is connected to the pressure detection passage 251 of the pressure detection pipe 25. The pump 22 may be used as a pressure adjustment device which pressurizes or depressurizes an inside of the fuel tank 10, and the pressure detection pipe 25 may used as a pressure-detection-passage forming member that defines the pressure detection passage 251. The pump 22 pressurizes or depressurizes the inside of the fuel tank 10 through the pressure detection passage 251, the switching valve 30, a canister port 211 and the canister 12. The pressure sensor 24 provided in the pressure detection pipe 25 detects a pressure in the fuel tank 10 by detecting a pressure in the pressure detection passage 251. The pressure sensor 24 may be used as an example of a pressure detection device which detects a pressure in the pressure detection passage 251 to output a signal dependent on the detected pressure.

The switching valve 30 is an electromagnetic valve, and includes a valve casing 32, the cover 47, a shaft 33, a first valve 50, a second valve 35 and an electromagnetic drive portion 34.

The valve casing 32 has a bottomed cylindrical shape, and accommodates therein the shaft 33, the first valve 50, the second valve 35 and the electromagnetic drive portion 34. An inside space of the valve casing 32 is partitioned by a partition wall 323 into a first space 321 and a second space 322, and the shaft 33 reciprocates across the first space 321 and the second space 322. The valve casing 32 has a non-shown discharge port in a side wall of the valve casing 32, through which the second space 322 communicates with an outside of the valve casing 32, i.e., the housing space 401. The first space 321 communicates with the canister port 211.

The cover 47 is a member having a flat plate shape, and is provided to close an opening of the valve casing 32 and to close the opening of the housing 40 that is open toward the canister 12. A first opening 51 of the first valve 50 is provided in a wall (inner wall) of the cover 47 located on a side of the cover 47 toward the housing space 401. The first opening 51 communicates with the pressure detection passage 251.

The canister connection portion 21, which defines the canister port 211, is located on a side of the cover 47 opposite from the housing space 401. The canister port 211 may be used as an example of a communication port communicating with the fuel tank 10, and the canister connection portion 21 may be used as an example of a communication port forming member that defines the communication port. An O-ring 212 is provided on a rim of an outer periphery wall of the canister connection part 21 to contact an inner wall of the attachment hole of the canister 12.

The bypass pipe 26 and the pressure detection pipe 25 are provided in the canister connection portion 21. The bypass pipe 26 defines a bypass passage 261 through which the canister port 211 communicates with the pressure detection passage 251. The pressure detection pipe 25 defines the pressure detection passage 251. The bypass pipe 26 may be used as an example of a bypass passage forming member which defines the bypass passage 261. The orifice 27 is provided in the bypass passage 261, and the canister port 211 thus communicates with the pressure detection passage 251 via the orifice 27. The orifice 27 may be used as an example of a narrowing portion provided in the bypass passage 261 to reduce a flow rate of air flowing therethrough. The orifice 27 has a hole having a size corresponding to an upper limit of allowable amount of leakage of air containing fuel vapor from the fuel tank 10.

The shaft 33 is provided coaxially with a center axis of the switching valve 33. The shaft 33 includes a main part 331, an edge part 332, a small diameter part 333, a flange part 334 and a large diameter part 335 which are coaxial with one another. The main part 331 is connected to a movable core 38. As shown in FIGS. 3A and 3B, the large diameter part 335, the flange part 334, the small diameter part 333 and the edge part 332 are arranged in this order from the main part 331 toward the first valve 50.

The edge part 332 of the shaft 33 has a tapered shape. An end of the edge part 332 having a largest diameter is connected to one end of the small diameter part 333. The other end of the small diameter part 333 is connected to the flange part 334. The small diameter part 333 has a cylindrical shape. A diameter of the small diameter part 333 is smaller than the largest diameter of the edge part 332, and is smaller than a diameter of the flange part 334.

The flange part 334 has a diameter largest in the shaft 33. The flange part 334 is accommodated in a recessed part 533 of a restriction plate 53. In the recessed part 533, a guide part 523 of a first valve member 52 is also accommodated. The flange part 334 is connected to the large diameter part 335 on a side of the flange part 334 opposite from the small diameter part 333.

The large diameter part 335 has a cylindrical shape and connects the main part 331 and the flange part 334. A diameter of the large diameter part 335 is larger than a diameter of the main part 331. The restriction plate 53 and a second valve member 352 are provided radially outward of the large diameter part 335.

As shown in FIGS. 3A and 3B, the restriction plate 53 includes a main body 531 extending outward in a radial direction of the shaft 33 from the large diameter part 335 to have a disc-like shape, and a thick part 532 protruding in an axial direction of the shaft 33 from the main body 531 toward the first valve member 52 to have an approximately cylindrical shape. The restriction plate 53 further includes a protrusion portion that protrudes in an axial direction of the shaft 33 from a radially inner part of the main body 531 on a side of the main body 531 opposite from the thick part 532 to be in contact with the second valve member 352. The recessed part 533 is provided on a radially inner side of the thick part 532.

A retainer 36 is provided on a radially outer side of the main part 331. The retainer 36 is, for example, press-fitted and fixed to the shaft 33 to be rotated integrally with the shaft 33. The retainer 36 includes a first protrusion part 361, a second protrusion part 362 and a third protrusion part 363 which are arranged in this order from the first valve 50 toward the movable core 38 as shown in FIG. 1. The restriction plate 53 and the second valve member 352 are sandwiched between the flange part 334 of the shaft 33 and the first protrusion part 361 in the axial direction of the shaft 33 as shown in FIGS. 3A and 3B.

The first valve 50 includes the cover 47 having a first seat portion 511 that defines the first opening 51. The first valve 50 further includes the first valve member 52 and the shaft 33 supporting the first valve member 52. The cover 47 may be used as an example of a first valve body including the first seat portion 511 that defines the first opening 51.

The first opening 51 extends in the axial direction of the switching valve 30 and has a shape (contra-tapered shape) in which a cross-sectional area of the first opening 51 decreases gradually in a direction from the first space 321 to the pressure detection passage 251. A center axis of the first opening 51 is coaxial with the center axis of the switching valve 30. The first seat portion 511 protrudes into the first space 321 as shown in FIGS. 3A and 3B. The first valve member 52 has a surface 525 that contacts the first seat portion 511 when the first opening 51 is closed.

The first valve member 52 has a disc-like shape and is made of an elastic member such as rubber. The first valve member 52 includes a body part 521, the guide part 523 and a radially outer part 524. The body part 521 has a through hole 522 that is located at a radially center of the body part 521. The small diameter part 333 of the shaft 33 extends through the through hole 522 to support the first valve member 52 as shown in FIGS. 3A and 3B. The guide part 523 is located on a side of the body part 521 toward the restriction plate 53 to guide the edge part 332 of the shaft 33. In other words, the guide part 523 is located between the body part 521 and the flange part 334. The body part 521 has a diameter approximately same as the diameter of the flange part 334 of the shaft 33, and the radially outer part 524 extends in the radial direction of the shaft 33 outward from the body part 521. A clearance is provided between the radially outer part 524 of the first valve member 52 and the thick part 532 of the restriction plate 53 such that the first valve member 52 can be deformed elastically and sufficiently. The first valve member 52 is located between the edge part 332 and the flange part 334 of the shaft 33 in the axial direction of the shaft 33 to contact both the edge part 332 and the flange part 334. The guide part 523 contacts the flange part 334 in the axial direction, and the body part 521 contacts the edge part 332 in the axial direction. A diameter of an end of the first seat portion 511 that contacts the surface 525 may be larger than or equal to the diameter of the body part 521 of the first valve member 52.

The second valve 35 includes the partition wall 323 having a second seat portion 353 that defines a second opening 351. The second valve 35 further includes a second valve member 352 and the shaft 33 supporting the second valve member 352. The second valve member 352 is made of an elastic member such as rubber. When the second valve member 352 moves with the shaft 33 to contact the second seat portion 353, the second opening 351 is closed so that the first space 321 is separated from the second space 322. The second valve member 352 contacts the second seat portion 353 in an entire circumference of the second seat portion 353 with deforming elastically due to a force from the second seat portion 353. The partition wall 323 may be used as an example of a second valve body including the second seat portion 353 that defines the second opening 351, and the first valve 50 and the second valve 35 are used as an example of the valve device of the present disclosure.

The electromagnetic drive portion 34 is an electromagnetic actuator that generates a magnetic attraction force by energization thereof. The electromagnetic drive portion 34 includes a yoke 324, a yoke 325, a bobbin 326, the coil 31, a magnetic plate 327, a fixed core 37 and the movable core 38. The movable core 38 is provided on a side the shaft 33 opposite from the first valve 50 in the axial direction of the shaft 33, and the fixed core 37 is provided on a side of the movable core 38 opposite from the shaft 33 in the axial direction. The fixed core 37 is located inside the coil 31.

The yoke 324 is made of a magnetic material such as iron to have a cylindrical shape. The yoke 324 is provided along an inner wall of the valve casing 32 on a radially outer side of the coil 31. The yoke 325 is made of a magnetic material such as iron, and is provided in an end part of the coil 31 on its side toward the connector 29, as shown in FIG. 1.

The bobbin 326 is made of resin to have a cylindrical shape, and is provided on a radially outer side of the fixed core 37. The coil 31 is obtained by winding a wire on a radially outer side of the bobbin 326. The coil 31 generates a magnetomotive force by energization thereof.

The magnetic plate 327 includes an annular body part provided in an end part of the coil 31 on its side opposite from the yoke 325. The magnetic plate 327 further includes a cylindrical portion 328 extending from a radially inner part of the annular body part toward the fixed core 37. The magnetic plate 327 constitutes a part of a magnetic circuit together with the yokes 324 and 325. An inner wall 329 of the cylindrical part 328 supports the movable core 38 such that the movable core 38 is made to be slideable in the axial direction.

The fixed core 37 is provided on the center axis of the switching valve 30, and an end of the fixed core 37 on an opposite side of the movable core 38 is fixed to the yoke 325. The fixed core 37 attracts the movable core 38 by the magnetomotive force generated by energization of the coil 31.

The movable core 38 is provided on the center axis of the switching valve 30, and is located on a side of the fixed core 37 toward the first valve 50. An outer periphery of the movable core 38 is supported slideably by the inner wall 329 of the cylindrical part 328 of the magnetic plate 327. An outer diameter of the movable core 38 is set smaller than a diameter of the inner wall 329 such that the movable core 38 is made to be slideable smoothly.

The movable core 38 includes a spring accommodation part 381 located on a side of the movable core 38 toward the fixed core 37 in the axial direction. The spring accommodation part 381 is recessed part, and accommodates therein a part of a return spring 39. The return spring 39 is provided between the fixed core 37 and the movable core 38, and urges these two cores 37 and 38 to separate them from each other.

The movable core 38 includes a fixation hole 382 located on a side of the movable core 38 toward the shaft 33, and the shaft 33 is inserted to the fixation hole 382 by press-fitting for example. Hence, an end of the shaft 33 on its side toward the movable core 38 is fixed to the fixation hole 382 of the movable core 38 by press-fitting for example. Alternatively, the end of the shaft 33 may be inserted into the fixation hole 382, and may be engaged with the fixation hole 382 by crimping for example. Accordingly, the shaft 33 reciprocates integrally with the movable core 38.

When the coil 31 of the switching valve 30 is not energized, a magnetic attraction force is not generated between the fixed core 37 and the movable core 38. Thus, the shaft 33 integrated with the movable core 38 is located on a right side in FIG. 1 due to an urging force of the return spring 39. In other words, the shaft 33 is located at a position where the surface 525 of the first valve member 52 contacts the first seat portion 511 to close the first opening 51 as shown in FIG. 3B. On the other hand, the second valve member 352 is separated from the partition wall 323 as shown in FIG. 1, so that the first space 321 communicates with the second space 322. Therefore, when the energization of the coil 31 is stopped, the communication between the canister port 211 and the pressure detection passage 251 through the first space 321 is interrupted, and the canister port 211 communicates with the pressure detection passage 251 only through the orifice 27 provided in the bypass passage 261.

When the coil 31 is energized by a command from the ECU 6, a magnetic attraction force is generated between the fixed core 37 and the movable core 38. Thus, the shaft 33 integrated with the movable core 38 moves toward a left side in FIG. 1 against the urging force of the return spring 39. The surface 525 of the first valve member 52 is separated from the first seat portion 511 to open the first opening 51 as shown in FIG. 3A, and the second valve member 352 closes the second opening 351. Accordingly, the first space 321 communicates with the pressure detection passage 251, so that the canister port 211 communicates with the pressure detection passage 251 through the first space 321. Because the second valve member 352 closes the second opening 351, the communication between the first space 321 and the second space 322 is interrupted. When the coil 31 is energized, an air flow between the canister port 211 and the pressure detection passage 251 is allowed, and an air flow between the canister port 211 and the atmosphere through the second space 322 is blocked. The canister port 211 communicates with the pressure detection passage 251 through the orifice 27 regardless of the energization of the coil 31.

Next, an operation of the fuel-vapor leak detection device 2 according to the first embodiment of the present disclosure will be described. The fuel-vapor leak detection process will be described, in which leakage of fuel vapor from the fuel tank 10 is detected by decompressing the inside of the fuel tank 10.

When a predetermined time has elapsed after a stop of the engine 5 of a vehicle, the ECU 6 is activated by a soak timer to start a detection of leakage of fuel vapor from the fuel tank 10. In the detection, an atmosphere pressure is measured firstly in order to correct an error due to an altitude of the vehicle parked. When the coil 31 is not energized, the atmosphere passage 281 communicates with the canister port 211 through the housing space 401, the second space 322 and the first space 321. The canister port 211 communicates with the pressure detection passage 251 through the bypass passage 261. In other words, the pressure detection passage 251 communicates with the atmosphere through the bypass passage 261. The pressure sensor 24 arranged in the pressure detection passage 251 detects the atmosphere pressure by detecting a pressure in the pressure detection passage 251 communicating with the atmosphere. After the detection of the atmosphere pressure is finished, the ECU 6 calculates the altitude of a place where the vehicle is parked based on the detected atmosphere pressure.

Subsequently, the ECU 6 energizes the coil 31 of the switching valve 30. The switching valve 30 causes the canister port 211 to be separated from the atmosphere passage 281, and to communicate with the pressure detection passage 251 through the first space 321. Accordingly, the pressure detection passage 251 is capable of communicating with the fuel tank 10 without through the orifice 27 of the bypass passage 261.

When the pressure sensor 24 detects a pressure increase due to a generation of fuel vapor in the fuel tank 10, the ECU 6 stops the energization of the coil 31. When the energization of the coil 31 is stopped, the pressure detection passage 251 is made to communicate with the canister port 211 and the atmosphere passage 281 through the bypass passage 261 without through the first space 321.

Additionally, when the pressure sensor 24 detects the pressure increase, an energization of the pump 22 is started to decompress the pressure detection passage 251 so that air is introduced into the pressure detection passage 251 from the atmosphere through the atmosphere passage 281, the second space 322, the first space 321, the canister port 211 and the bypass passage 261. Because the air flow introduced into the pressure detection passage 251 is narrowed by the orifice 27, a pressure in the pressure detection passage 251 is decreased. The pressure in the pressure detection passage 251 decreases to a predetermined pressure corresponding to an opening area of the orifice 27, and becomes constant eventually. The detected constant pressure in the pressure detection passage 251 is stored as a reference pressure. The energization of the pump 22 is terminated after the detection of the reference pressure is finished.

When the detection of the reference pressure is finished, the ECU 6 energizes the coil 31. The canister port 211 is separated from the atmosphere passage 281, and is made to communicate with the pressure detection passage 251 through the first space 321. In other words, the inside of the fuel tank 10 communicates with the pressure detection passage 251 through the first space 321, and a pressure in the pressure detection passage 251 thereby becomes equal to a pressure in the fuel tank 10.

When the canister port 211 is made to communicate with the pressure detection passage 251, the pump 22 is activated to decompress the inside of the fuel tank 10. When the pressure in the pressure detection passage 251, i.e, the pressure in the fuel tank 10 becomes lower than or equal to the detected reference pressure by operating the pump 22 continuously, a leakage amount of air containing fuel vapor from the fuel tank 10 is determined to be lower than or equal to the allowable amount. In other words, when the pressure in the fuel tank 10 is lower than the reference pressure, there is no inflow of air into the fuel tank 10 from outside, or an amount of the air flowing into the fuel tank 10 is lower than or equal to the allowable amount corresponding to the hole size of the orifice 27. Therefore, air sealing of the fuel tank 10 is determined to be ensured sufficiently.

On the other hand, when the pressure in the fuel tank 10 does not become lower than or equal to the reference pressure even by operating the pump 22 continuously, the leakage amount of air containing fuel vapor from the fuel tank 10 is determined to be higher than the allowable amount. In other words, when the pressure in the fuel tank 10 does not become lower than the reference pressure, more than the allowable amount of air may flow into the fuel tank 10 from outside due to the pressure decrease in the fuel tank 10. As a result, the air sealing of the fuel tank 10 is determined not to be ensured.

When the detection of the leakage of the air containing fuel vapor is finished, the energization of the pump 22 and the energization of the switching valve 30 are terminated. Subsequently, a pressure in the pressure detection passage 251 increases to the atmosphere pressure, and the ECU 6 then stops the operation of the pressure sensor 24, so that the fuel-vapor leak detection process is finished.

In the fuel-vapor leak detection process described above, the first valve 50 connects or disconnects the first space 321 and the pressure detection passage 251 as shown in FIGS. 3A and 3B. Because the outer diameter of the movable core 38 is smaller than the diameter of the inner wall 329, the shaft 33 may reciprocate in a state where the shaft 33 is inclined from the center axis of the first opening 51. In other words, a reciprocation direction of the shaft 33 may be inclined from the center axis of the first opening 51. In this case, when the first valve member 52 contacts the first seat portion 511 to close the first opening 51 in the fuel-vapor leak detection device 2 of the first embodiment, a part of the surface 525 of the first valve member 52 having the disc-like shape firstly contacts the first seat portion 511 that defines the first opening 51. Subsequently, the other part of the surface 525 of the first valve member 52 contacts the first seat portion 511 while the first valve member 52 is deforming. Accordingly, the first space 321 can be separated from the pressure detection passage 251 unfailingly.

In the fuel-vapor leak detection device 2 including the first valve 50 of the first embodiment, the first valve member 52 is made of the elastic member to have the disc-like shape. Hence, the air sealing between the first space 321 and the pressure detection passage 251 can be ensured when the first opening 51 is closed. Even when the first valve member 52 contacts the first seat portion 511 while the reciprocation direction of the shaft 33 is inclined from the center axis of the first opening 51, the air sealing of the first valve 50 can be ensured. Furthermore, in the fuel-vapor leak detection device 2 of the first embodiment, there is no need to burn an elastic member into a surface of a resin material to provide the first valve member 52, and there is no necessity to make the edge part 332 of the shaft 33 into a hemispherical shape. Therefore, a manufacturing cost of the fuel-vapor leak detection device 2 can be reduced.

The first valve member 52 is capable of deforming elastically by utilizing the clearance provided between the first valve member 52 and the restriction plate 53. Thus, even when the reciprocation direction of the shaft 33 is inclined from the center axis of the first opening 51, the surface 525 of the first valve member 52 can be made to be in contact with the first seat portion 511 in an entire circumference of the first seat portion 511 with a relatively small urging force of the return spring 39. In other words, the first space 321 can be surely separated from the pressure detection passage 251 with the relatively small urging force of the return spring 39.

Because the first valve member 52 of the first valve 50 is supported by the small diameter part 333 of the shaft 33 in first embodiment, there is no need to provide another spring that urges the first valve member 52 toward the shaft 33. Hence, in the fuel-vapor leak detection device 2 including the first valve 50 of the first embodiment, a necessary urging force of the return spring 39 for separating the first space 321 from the pressure detection passage 251 can be set smaller than that in a case where the another spring is provided to urge the first valve member 52 toward the shaft 33.

As described above, the first space 321 can be surely separated from the pressure detection passage 251 with the relatively small urging force of the return spring 39, and the necessary urging force of the return spring 39 for separating the first space 321 from the pressure detection passage 251 can be made to be smaller in the first embodiment. Thus, the magnetic attraction force generated by the electromagnetic drive portion 34 for opening the first valve 50 and for closing the second valve 35 against the urging force of the return spring 39 can be reduced. Consequently, an electric power supplied to the electromagnetic drive portion 34 can be reduced.

Because the electric power supplied to the electromagnetic drive portion 34 can be reduced, temperature increase of the fuel-vapor leak detection device 2 can be restricted. As a result, a range of ambient temperature, within which the fuel-vapor leak detection device 2 can be operated, can be expanded.

The first seat portion 511 that defines the first opening 51 protrudes into the first space 321 in which the first valve member 52 is accommodated. Accordingly, an area of the first seat portion 511 that contacts the first valve member 52 is smaller than that in a case where the first seat portion 511 does not protrude and is formed in a flat shape. In other words, because the first seat portion 511 protrudes into the first space 321 toward the first valve member 52, a contact area between the first seat portion 511 and the first valve member 52 can be made to be small relatively. Therefore, the first space 321 can be surely separated from the pressure detection passage 251 with a relatively small force. As a result, the electric power supplied to the electromagnetic drive portion 34 can be further reduced.

### Second Embodiment

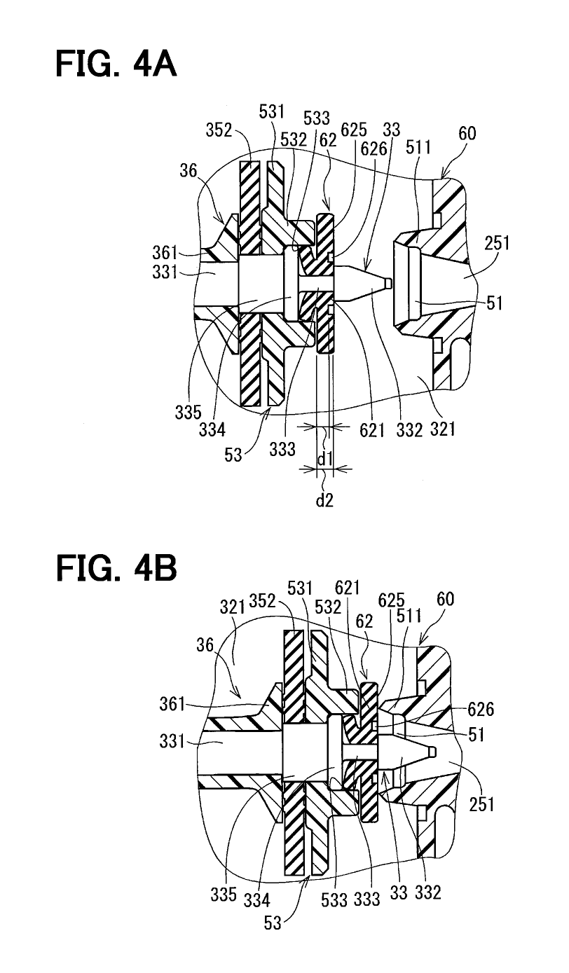

A fuel-vapor leak detection device including a valve device according to a second embodiment of the present disclosure will be described referring to FIGS. 4A and 4B. A shape of a first valve member 62 of the second embodiment is different from the shape of the first valve member 52 of the first embodiment. A part of the second embodiment substantially same as a part of the first embodiment is assigned a same numeral as the part of the first embodiment, and an explanation of the part of the second embodiment may be omitted.

A recess portion 626 is provided in a surface 625 of the first valve member 62 of a first valve 60, and the surface 625 is located on a side of the first valve member 62 toward a first opening 51. The recess portion 626 has an annular shape when the surface 625 is viewed in a center axis of the first opening 51. As shown in FIG. 4B, the recess portion 626 is located on a radially inner side of a part of the surface 625 that contacts a first seat portion 511.

The recess portion 626 is provided by reducing a thickness of a body part 621 of the first valve member 62 in an axial direction of the first valve member 62. Specifically, as shown in FIGS. 4A and 4B, a thickness d1 of a part of the body part 621, where the recess portion 626 is provided, is thinner than a thickness d2 of a part of the body part 621, where the recess portion 626 is not provided. Because of the recess portion 626, the first valve member 62 can be easily deformed toward a restriction plate 53 by a force applied on the body part 621 when the body part 621 contacts the first seat portion 511. Therefore, in the fuel-vapor leak detection device using the first valve 60 of the second embodiment, a necessary force for making the body part 621 be in contact with the first seat portion 511 in an entire circumference of the first seat portion 511 can be further reduced in addition to the effects of the first embodiment.

Although the present disclosure has been fully described in connection with the preferred embodiments thereof with reference to the accompanying drawings, it is to be noted that various changes and modifications described below will become apparent to those skilled in the art.

In the above-described second embodiment, the recess portion 626 is provided in the surface 625 of the body part 621, and is located on the side of the body part 621 toward the first opening 51. However, the position of the recess portion 626 is not limited to this. For example, the recess portion 626 may be provided on a side of the body part 621 opposite from the first opening 51, and may be provided on the both sides of the body part 621 in the axial direction of the first valve member 62.

In the above-described embodiments, the first seat portion 511 that defines the first opening 51 protrudes into the first space 321 that is a space inside the housing 40. However, the shape of the first seat portion 511 is not limited to this, and may be a flat surface coplanar with a surface of the cover 47.

In the above-described embodiments, a fuel-vapor leakage from the fuel tank 10 or the like is detected by depressurizing. However, the fuel-vapor leakage may be detected by pressurizing.

The present disclosure is not limited to the above embodiments, and is feasible in various embodiments without departing from a scope of the present disclosure.

Additional advantages and modifications will readily occur to those skilled in the art. The disclosure in its broader terms is therefore not limited to the specific details, representative apparatus, and illustrative examples shown and described.

What is claimed is:

1. A valve device comprising:
a first valve body including a first seat portion that defines a first opening;
a shaft reciprocatable in a direction of a center axis of the first opening; and
a first valve member supported by the shaft to contact or be separated from the first seat portion in accordance with the reciprocation of the shaft, wherein
the first valve member contacts the first seat portion in an entire circumference of the first seat portion with deforming elastically due to a force from the first seat portion when the first valve member contacts the first seat portion in a state where a reciprocation direction of the shaft is inclined from the center axis of the first opening.

2. The valve device according to claim 1, wherein
the first valve member has a recess portion having an annular shape, and
the recess portion is located on a radially inner side of a part of the first valve member that contacts the first seat portion.

3. The valve device according to claim 1, wherein the first seat portion protrudes from the first valve body toward the first valve member.

4. The valve device according to claim 1, wherein
the shaft includes:
an edge part that is located an end of the shaft and has a shape tapered in a direction toward the first opening;
a small diameter part connected to a side of the edge part having a largest diameter of the edge part, the small diameter part having a diameter smaller than the largest diameter of the edge part; and
a flange part connected to a side of the small diameter part opposite from the edge part, the flange part having a diameter larger than the diameter of the small diameter part,
the first valve member includes a through hole having a diameter that is smaller than the diameter of the flange part and smaller than the largest diameter of the edge part, and
the small diameter part of the shaft extends through the through hole to support the first valve member.

5. The valve device according to claim 1, further comprising:
a second valve body including a second seat portion that defines a second opening; and
a second valve member supported by the shaft that is reciprocatable in a direction of a center axis of the second opening, wherein
the second valve member contacts or is separated from the second seat portion in accordance with the reciprocation of the shaft,
the first valve member contacts the first seat portion when the second valve member is separated from the second seat portion, and
the first valve member is separated from the first seat portion when the second valve member contacts the second seat portion.

6. The valve device according to claim 5, wherein the second valve member contacts the second seat portion in an entire circumference of the second seat portion with deforming elastically due to a force from the second seat portion.

7. The valve device according to claim 5, further includes a restriction plate that extends from the shaft outward in a radial direction of the shaft and is located between the flange part and the second valve member in an axial direction of the shaft, wherein
the restriction plate includes:
a main body extending outward in the radial direction of the shaft to have a disc-like shape; and
a thick part protruding in the axial direction of the shaft from the main body toward the first valve member on a radially outer side of the flange part to provide a clearance between the thick part and the first valve member in the axial direction.

8. A fuel-vapor leak detection device which detects a leakage of fuel vapor from a fuel tank, the fuel-vapor leak detection device comprising:
a housing;
a communication port forming member which defines a communication port communicating with the fuel tank;
an atmosphere passage forming member which defines an atmosphere passage through which an inside of the housing communicates with an outside of the housing;
a pressure-detection-passage forming member which defines a pressure detection passage capable of communicating with the communication port;
a switching valve including the valve device according to claim 5 to selectively switch a communication state of the communication port between a state where the communication port communicates with the pressure detection passage via the first opening and a state where the communication port communicates with the atmosphere passage via the second opening;
a pressure adjustment device which pressurizes or depressurizes an inside of the fuel tank when the communication port communicates with the pressure detection passage;
a bypass passage forming member which defines a bypass passage through which the communication port bypasses the switching valve to communicate with the pressure detection passage;
a narrowing portion provided in the bypass passage to reduce a flow rate of air flowing therethrough; and
a pressure detection device which detects a pressure in the pressure detection passage to output a signal dependent on the detected pressure.
